(19) United States
(12) Patent Application Publication
(10) Pub. No.: US 2003/0098566 A1
(43) Pub. Date: May 29, 2003

(54) Lever operated foot pump scooter

(76) Inventors: Donald J. Christensen, Phoenix, AZ (US); Lewis Ghiz, Tempe, AZ (US); Jonathan L. Perryman, Phoenix, AZ (US)

Correspondence Address: C. Robert von Hellens, CAHILL, VON HELLENS & GLAZER P.L.C., Suite 155, 2141 E. Highland Avenue, Phoenix, AZ, 85016, US

(21) Appl. No.: 10/288,755

(22) Filed: Nov. 6, 2002

Related U.S. Application Data
(63) Continuation-in-part of application No. 10/057,325, filed on Oct. 29, 2001.
(60) Provisional application No. 60/287,839, filed on May 1, 2001.
(60) Provisional application No. 60/318,192, filed on Sep. 7, 2001.

(51) Int. Cl. B62M 1/00

(52) U.S. Cl. 280/221

(57) ABSTRACT

A front wheel of a scooter is pivotally mounted to a frame and includes an upwardly extending shaft supporting a handlebar for steering the scooter. The fore and aft position of the handlebar may be adjustable for comfort to the rider. A pivotally mounted spring returned lever is interconnected with the rear wheel through a gear mechanism supported by the frame. A gear shift mechanism may be incorporated. By pumping the lever, rotation of the rear wheel and forward motion of the scooter occurs.

### CROSS REFERENCE TO RELATED APPLICATIONS

The present application is a continuation-in-part application of and claims priority to a utility application entitled “Foot Pump Scooter”, filed Oct. 29, 2001, and assigned Ser. No. 10/057,325, which application claims priority to two provisional applications entitled “FOOT-PUMP SCOOTER”, filed May 1, 2001 and assigned Serial No. 60/287,839 and provisional application entitled “PUMP SCOOTER”, filed Sep. 7, 2001 and assigned Serial No. 60/318,192.

### BACKGROUND OF THE INVENTION

1. Field of the Invention

The present invention relates to scooters and, more particularly, to scooters propelled forwardly by a rider operated pivotally mounted lever.

2. Description of Related Art

Conventional scooters are propelled forwardly by a rider having one foot on a platform between the front and rear wheels and pushing rearwardly against the ground with the other foot. Such scooters are speed limited on a flat surface by the speed and power of the rider pushing rearwardly against the ground. Because of the physical effort required, scooters of this type are relatively slow and higher speeds are possible only for short periods of time.

To increase the sustainable duration at a higher speed, various foot operated motive mechanisms have been developed. One type of mechanism includes a foot operated lever repetitively drawing a chain in contact with a sprocket secured to the rear wheel through a one way clutch. In another type of self propelled scooter, a pair of footpads or pegs are pumped by the rider's feet, which pumping motion is translated to rotary motion of the rear wheel. These mechanisms overcome the need to repeatedly push against the ground with one of the rider's feet but various detrimental aspects exist. For example, the resulting speed of the scooter is little more, if any, beyond that of a conventional scooter wherein the same amount of effort is applied. The dual foot pedal arrangement negates the existence of a solid platform upon which a rider may rest his feet as he wishes. Certain of the mechanisms are complex, expensive and of limited life in the environment within which a scooter is expected to be used by a child or young adult.

### SUMMARY OF THE INVENTION

The present invention is directed to a scooter mechanically propelled by a rider and having a front wheel steerable through the handlebar. A spring returned arcuate lever is repetitively depressed by a rider's foot. The resulting movement of the lever rotates an engaged initial sprocket mounted on a shaft. A chain and sprocket mechanism interconnects the initial sprocket with a clutch mechanism attendant a final sprocket mounted on a shaft and keyed with the rear wheel. The one way clutch permits return of the lever and freewheeling of the rear wheel. By selecting a gear ratio of the gear mechanism commensurate with the strength and weight of the rider, a significantly increased forward speed over that of a conventional foot powered scooter can be achieved.

It is therefore a primary object of the present invention to provide a foot operated mechanism for a scooter to compel forward motion.

Another object of the present invention is to provide a lever operated gear mechanism for propelling a scooter.

Yet another object of the present invention is to provide a simple foot operated gear mechanism for propelling a scooter.

Still another object of the present invention is to provide a foot operated gear mechanism adapted for use within the normal environment of a scooter without significant danger of jamming or breakdown.

A further object of the present invention is to provide a relatively inexpensive and easily repairable foot operated gear mechanism for propelling a scooter.

A yet further object of the present invention is to provide a foot operated gear mechanism intermittently actuated to permit a rider to rest while the scooter coasts.

A still further object of the present invention is to provide a method for propelling a scooter by a pumping action of a rider's foot.

These and other objects of the present invention will become apparent to those skilled in the art as the description of the invention proceeds.

### BRIEF DESCRIPTION OF THE DRAWINGS

The present invention maybe described with greater specificity and clarity with reference to the following drawings, in which:

FIG. 1 illustrates a perspective view of a foot operated gear mechanism mounted on a scooter;

FIG. 2 is a cross sectional view taken along lines 2-2, as shown in FIG. 1;

FIG. 3 is a partial side view of the final stage of the gear mechanism;

FIG. 4 is an exploded view of the gear mechanism;

FIG. 5 illustrates the movement of the foot operated lever;

FIGS. 6a and 6b illustrate the support structure for the gear mechanism;

FIG. 7 illustrates the common axis of the initial and final sprockets of the gear mechanism;

FIG. 8 illustrates a first side view of a variant gear mechanism;

FIG. 9 illustrates another side view of the variant gear mechanism;

FIG. 10 illustrates a gear mechanism mounted at the front of the scooter for driving the rear wheel;

FIG. 11 illustrates a further view of the front mounted gear mechanism;

FIG. 12 is a left rear perspective view of a foot operated gear mechanism mounted at the rear of a scooter;

FIG. 13 is a left side elevational view of the scooter shown in FIG. 12;

FIG. 14 is a right side elevational view of the scooter shown in FIG. 12;

FIG. 15 illustrates the steering mechanism for the front wheel of the scooter;

FIG. 16 is a cross sectional view taken along lines 16-16, as shown in FIG. 15;

FIG. 17 is an end view taken along lines 17-17, as shown in FIG. 14;

FIG. 18 is a partial exploded view of the gear mechanism shown in FIG. 12;

FIG. 19 illustrates operation of the foot operated lever;

FIG. 20 is a cross sectional view taken along lines 20-20, as shown in FIG. 19;

FIG. 21 is a partial view of the brake assembly for the rear wheel; and

FIG. 22 illustrates a variant of the lever.

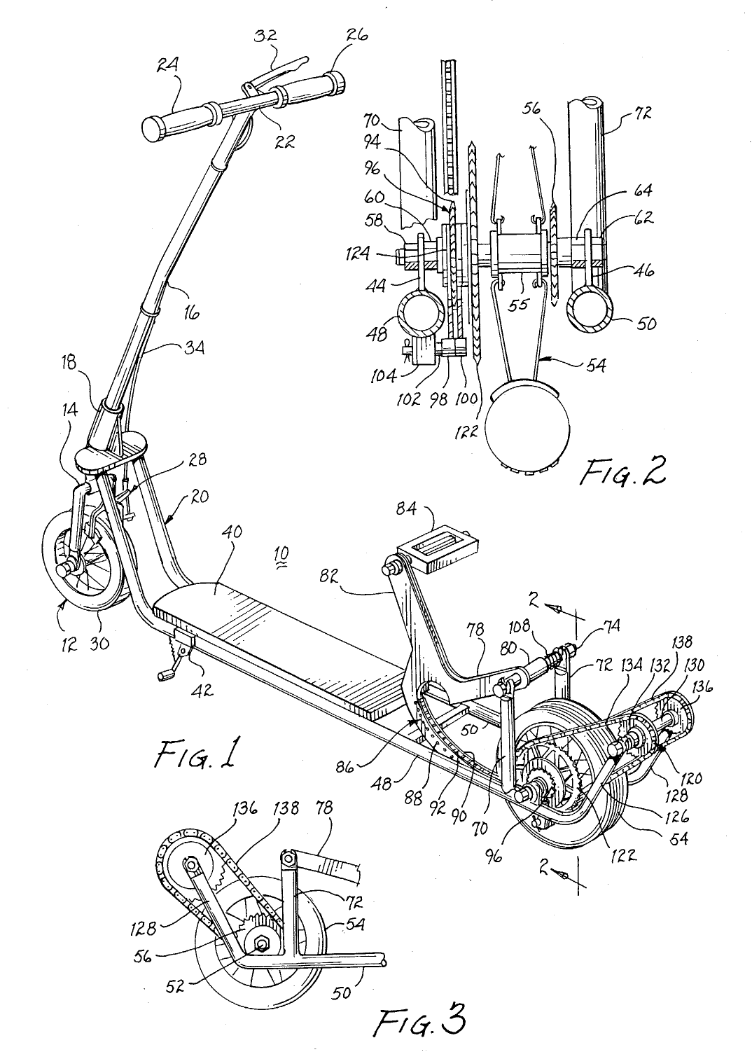

### DESCRIPTION OF THE PREFERRED EMBODIMENT

Referring to FIG. 1, there is shown a perspective view of a foot pump scooter 10 embodying the present invention. A front wheel assembly 12 is rotatably mounted within a fork 14 depending from a shaft 16 rotatably mounted in a sleeve 18 or the like secured to the front of frame 20. A handlebar 22 is attached at the upper end of shaft 16 and may include handgrips 24, 26. A caliper brake assembly 28 may be mounted on fork 14 to provide a braking function for wheel 30 of the front wheel assembly. A manually operated brake handle 32 mounted upon handlebar 22 actuates the caliper brake assembly through a sheathed cable 34.

Frame 20 of foot pump scooter 10 includes a platform 40 upon which a rider may place one or both of his feet. A spring loaded kickstand 42 may be attached to the frame to permit parking the foot pump scooter in an upright orientation.

Referring jointly to FIGS. 1, 2 3, 4, 5 and 7, details of the rear wheel assembly, it's mounting and the associated gear mechanism will be described. A pair of ears 44, 46 are secured to and extend upwardly from longerons 48, 50 of frame 20 to support and retain axle 52. The ears may include forwardly oriented slots to accommodate removal of the wheel assembly and to adjust the tension of the chains of the gear mechanism. The wheel mechanism includes a wheel 54 and hub 55 rotatably mounted upon axle 52. A final sprocket 56 is attached to the wheel and includes a one way clutch to permit rotation of the wheel in the forward direction of the scooter without requiring commensurate rotation of the sprocket. However, rotation of the sprocket in the forward direction compels commensurate rotation of the wheel through the clutch. As is conventional, nuts 58, 60 threadedly engage axle 52 and secure ear 44 therebetween. Similarly, nuts 62, 64 threadedly engage the axle and secure ear 46 therebetween. A pair of stanchions 70, 72 extend upwardly from longerons 48, 50, respectively, of frame 20. The upper ends of these stanchions support a shaft 74 extending therebetween. A lever assembly 76 includes an arm 78 terminated by a sleeve 80 rotatably mounted upon shaft 74. Thereby, lever assembly 76 is rotatable about the axis of shaft 74. The lever assembly includes a forwardly extending lever 82 supporting at it's extremity a peg 84 or a footpad. The peg or footpad may be rotatably attached to the lever in the conventional manner of a footpedal for a bicycle.

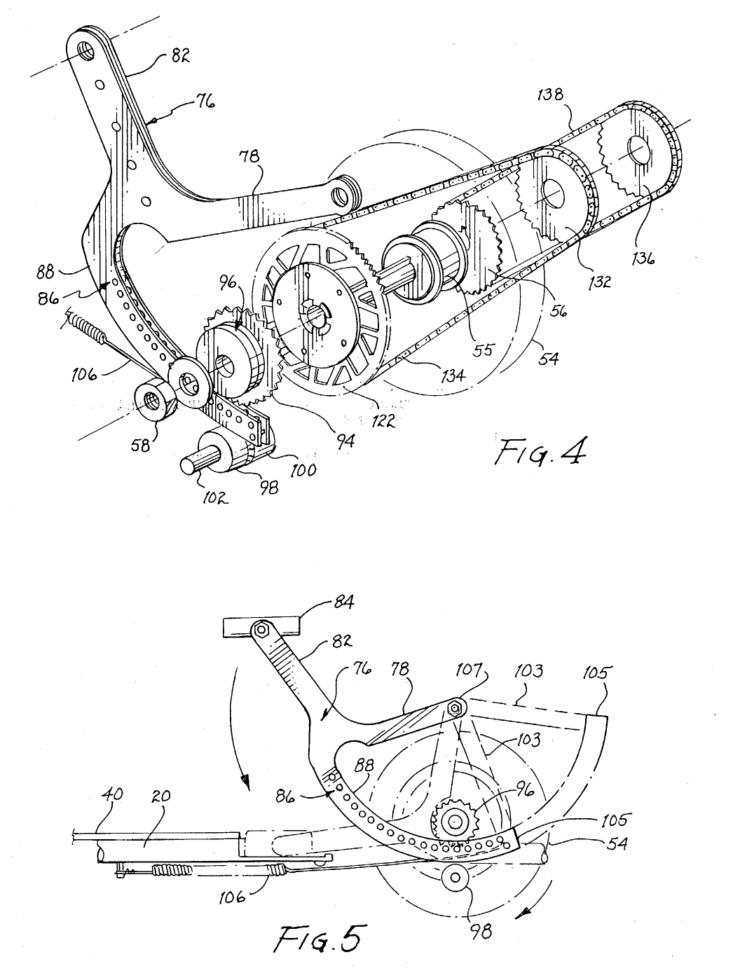

A ratchet-like bar 86 of the lever assembly extends rearwardly. It is of constant curvature and has an axis of rotation commensurate with the axis of shaft 74. Bar 86 may have attached thereto a length of conventional bicycle chain or it may include a pair of sidewalls 88, 90 between which are mounted a plurality of rods 92 spaced apart from one another commensurate with corresponding rods of a conventional bicycle chain. The rods of bar 86 engage teeth 94 of initial or first sprocket 96. The outer race of one or a pair of bearings 98, 100 are mounted upon a stud 102 secured to longeron 48 through a block 104. The purpose of these bearings is to insure continuing engagement of bar 86 with sprocket 96. Alternatively, a bar 103 (shown in dashed lines) may interconnect end 105 of bar 86 with journaled end 107 of arm 78 (see FIG. 5). This variation relieves certain loads on bar 86 and bearings 98, 100 may be eliminated. A spring 106 (see FIG. 4) is secured intermediate the extremity of bar 86 and an anchor on frame 20 to return the bar to its forward position absent pressure on footpad 84. Alternatively, a predetermined tension spring 108 (see FIG. 1) may be mounted on shaft 74 to return lever assembly 74 to the initial position.

Upon downward movement of the footpad, lever assembly 76 will rotate downwardly about the axis of shaft 74 and result in curvilinear movement of bar 86. Such movement of the bar will produce rotation of sprocket 96 due to the resulting consecutive engagement of rods 92 with teeth 94 of the sprocket. When the footpad is in its lower most position, pressure is removed from the footpad and the force of spring 106 (or tension spring 108) will draw bar 86 forwardly and rotational movement of lever assembly 76 to its initial position will occur. Commensurate rotation of first sprocket 96 in the opposite direction will also occur.

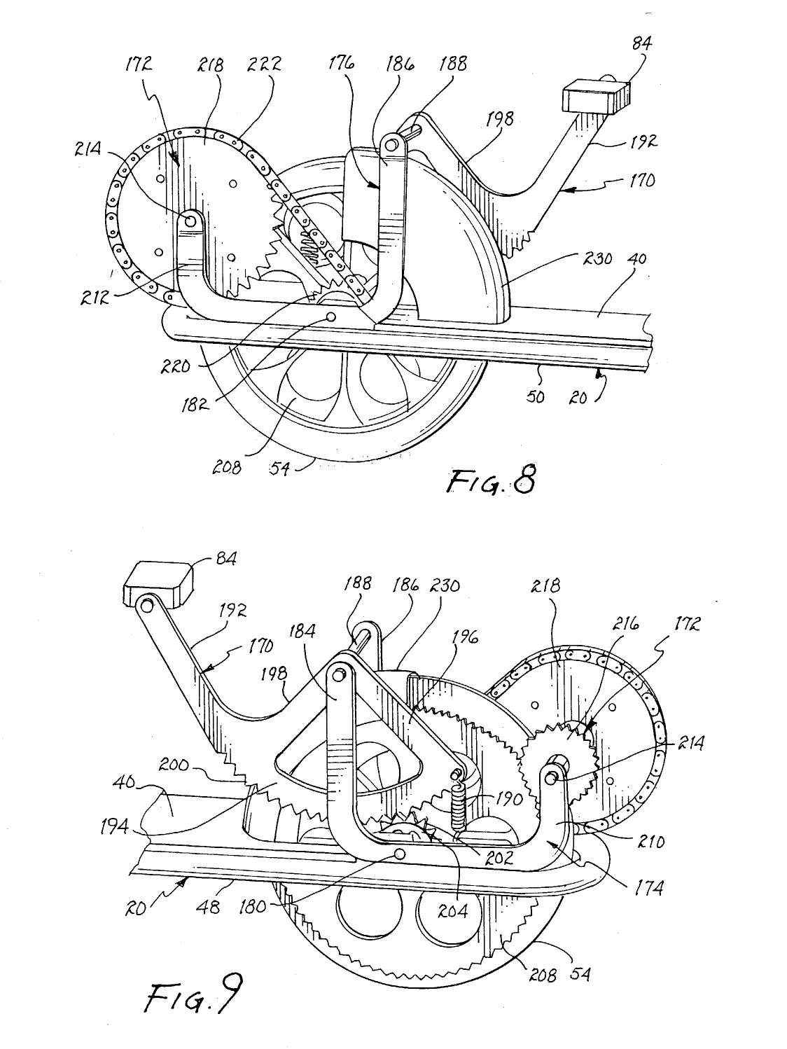

Referring jointly to FIGS. 2, 4, 5 and 7, further details of gear mechanism 120 will be described. First sprocket 96, mounted upon axle 52, is in engagement with second sprocket 122 through a one way clutch 124 whereby rotation of the first sprocket in one direction corresponding with downward stroke of lever assembly 76 will result in corresponding rotation of second sprocket 122 but rotation of the first sprocket in the other direction will have no effect upon the second sprocket. A pair of uprights 126, 128 extend from the rear of frame 20 and rotatably support a shaft 130. A third sprocket 132 is fixably attached to shaft 130. A loop of conventional bicycle chain 134 interconnects the third sprocket with the second sprocket. A fourth sprocket 136 is fixably attached to shaft 130. Thus, rotation of third sprocket 132 will result in rotation of shaft 130 and fourth sprocket 136. The fourth sprocket is attached to final sprocket 56 by a loop of conventional bicycle chain 138.

The number of revolutions of first sprocket 96 per downward stroke of lever assembly 76 is a function of the number of rods 92 present within bar 86. The size of second sprocket 122 is significantly greater than the size of first sprocket 96. The size of third sprocket 132 is significantly smaller than the size of the second sprocket and as these two sprockets are interconnected by chain 134, the number of revolutions of the third sprocket per revolution of the second sprocket is a function of the respective ratio of teeth. Third sprocket 132 maybe the same size as fourth sprocket 136, as illustrated, or the fourth sprocket may be of greater or lesser size. Final sprocket 56 may be of smaller size than fourth sprocket 136 resulting in the final sprocket rotating more than one revolution per revolution of the fourth sprocket as a ratio of the respective number of teeth as the two are interconnected with chain 138. Wheel 54 will be caused to rotate commensurate with final sprocket 56 in one direction as a result of the one way clutch disposed therebetween.

By inspection and a basic understanding of gear mechanisms, it is evident that gear mechanism 120 will result in final sprocket 56, and wheel 54, rotating at a greater rate of rotation than sprocket 96. This difference in rate of rotation is a function of the relative sprocket sizes and may be changed by changing the size of one or more of the sprockets.

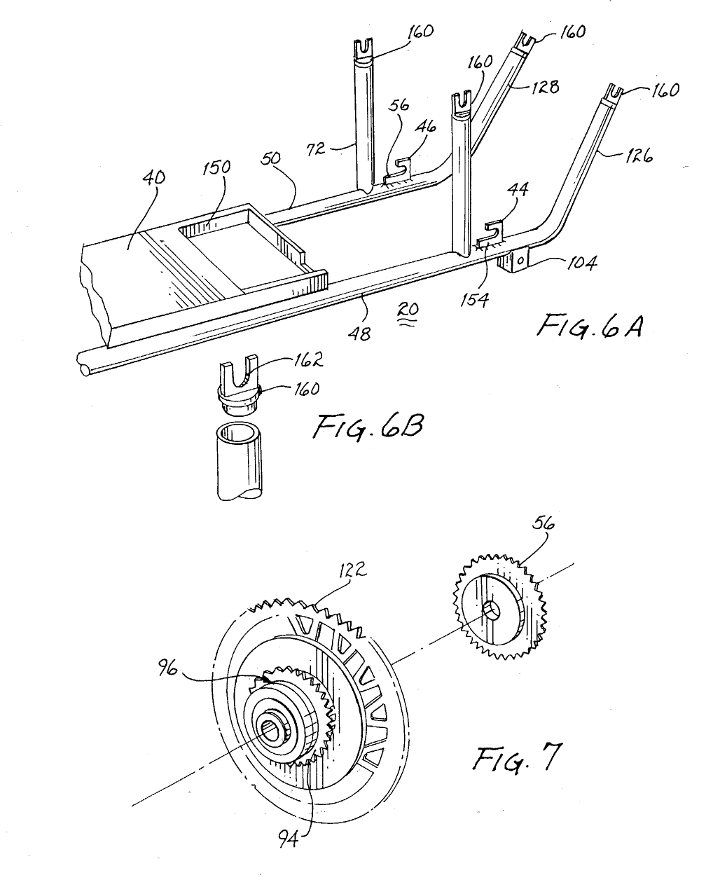

Referring jointly to FIGS. 6a and 6b, details of frame 20 supporting components of gear mechanism 120 will be described in further detail. Platform 40 may include an indentation 150 for receiving footpad 84 or a peg whereby the footpad/peg can become a part of platform 40 and provides an essentially planar surface upon which a rider may rest his feet. Thus, when lever assembly 76 is in its lowered position, foot pump scooter 10 may be used as a conventional scooter without interference from the lever assembly. As illustrated, a notch 152 may be incorporated to receive the corresponding part of lever 82. A simple locking mechanism may be added (not shown) to permit the lever assembly to be latched in the depressed position.

The above described slots in ears 44, 46 are illustrated in FIG. 6a and identified by reference numerals 154, 156 these slots permit fore and aft adjustment of axle 52 to place appropriate tension upon chains 134, 138 and to securely attach the axle to frame 20. The upper ends of uprights 70, 72 may include an insert 160 shown in FIG. 6b. This insert includes a slot 162 for receiving shaft 74. Similar inserts maybe mounted at the upper ends of uprights 126, 128 to engage and retain by nuts or the like shaft 130. As shaft 130 must translate rotational movement of the third sprocket to the fourth sprocket, the shaft must be journaled within the inserts at the ends of uprights 126, 128, which journals are not shown as they are well known to those skilled in the art. Block 104, for supporting bearings 98, 100, extends downwardly from the bottom of longeron 48 to position the bearings adjacent the lower edge of bar 86.

FIGS. 8 and 9 illustrate a variant 170 of lever mechanism 76 and a variant 172 of gear mechanism 120. For common elements previously shown and described, the same reference numerals will be used. A pair of U-shaped support members 174, 176 are attached to longerons 48, 50, respectively, of frame 20. Member 174 includes an aperture 180 for penetrable engagement by axle 52 (not shown); similarly, member 176 includes an aperture 182 for supporting the axle. The ends of arms 184, 186 support a shaft 188. Variant 170 of the lever assembly is pivotally mounted upon shaft 88 to permit pivotal movement of the variant in response to a downward force applied to footpad 84 or a peg or in response to spring 190. The variant includes a lever 192 for supporting the footpad or peg. An arced bar 194 extends rearwardly from lever 192. An arm 196 extends from essentially the rearward extremity of bar 194 and a second arm 198 extends from essentially the junction between bar 194 and lever 192. The two arms are joined to one another and pivotally supported by shaft 188. Upon downward motion of footpad 84 or peg or under the urging of spring 190 (or a tension spring 108), variant 170 will rock in one direction or the other about the axis of shaft 188.

Bar 194 of variant 170 defines an arc about the axis of shaft 188. The periphery of the arc portion of the bar includes a plurality of teeth 200. These teeth engage with teeth 202 of sprocket 204, the latter being rotatably mounted on the axle (not shown) supporting wheel 54. Thereby, upon depressing footpad 84 or a peg, variant 170 will pivot resulting in rotation of sprocket 204. It is to be understood that teeth 200 on bar 194 maybe gear teeth and that teeth 202 mate therewith and resulting in sprocket 204 being a gear. A gear 208 of greater diameter than sprocket 204 is mechanically attached to the sprocket whereby the gear rotates commensurate with rotation of the sprocket. Sprocket 204 includes a one way clutch to permit rotation of the sprocket in one direction without commensurate rotation of gear 208. Support members 174, 176 include uprights 210, 212, respectively, for rotatably supporting a shaft 214. A gear 216 includes teeth for meshing with the teeth of gear 208 whereby gear 208 imparts rotatory motion to gear 216 resulting in rotation of shaft 214. A sprocket 218 is fixedly attached to shaft 214 whereby the sprocket will rotate in conformance with rotation of gear 216. A sprocket 220 is attached to wheel 54 through a one way clutch. A chain 222, such as a conventional bicycle chain, interconnects sprocket 218 with sprocket 220.

Upon depressing footpad 84 or a peg, variant 170 will pivot about shaft 188 and impart a rotary motion to sprocket 204. The commensurate rotation of gear 208 will impart rotary motion to gear 216. The rate of rotation of gear 216 relative to gear 208 is a function of the ratio of the respective teeth. That is, due to the difference in size, gear 216 will rotate at a greater rate of rotation than gear 208. The rotation of gear 216 is translated to commensurate rotation of sprocket 218 and imparted to sprocket 220 through chain 222. The rate of rotation of sprocket 220 is greater than the rate of rotation of sprocket 218 as a function of the ratio of the respective number of teeth. When footpad 84 or a peg is permitted to rise in response to spring 190 (or tension spring 108), sprocket 204 will rotate in the opposite direction. However, as this sprocket is secured to gear 208 through a one way clutch, commensurate rotation of this gear will not occur. Correspondingly, wheel 206 will continue to rotate as a result of forward movement of the foot pump scooter and such rotation is not impeded by the lack of rotation of sprocket 220 due to the interconnecting one way clutch.

A guard 230, similar to a mud guard, serves the primary function of preventing injury to the feet of a rider by contact with either wheel 54 or any of the gears/sprockets/chains associated with variant gear mechanism 172.

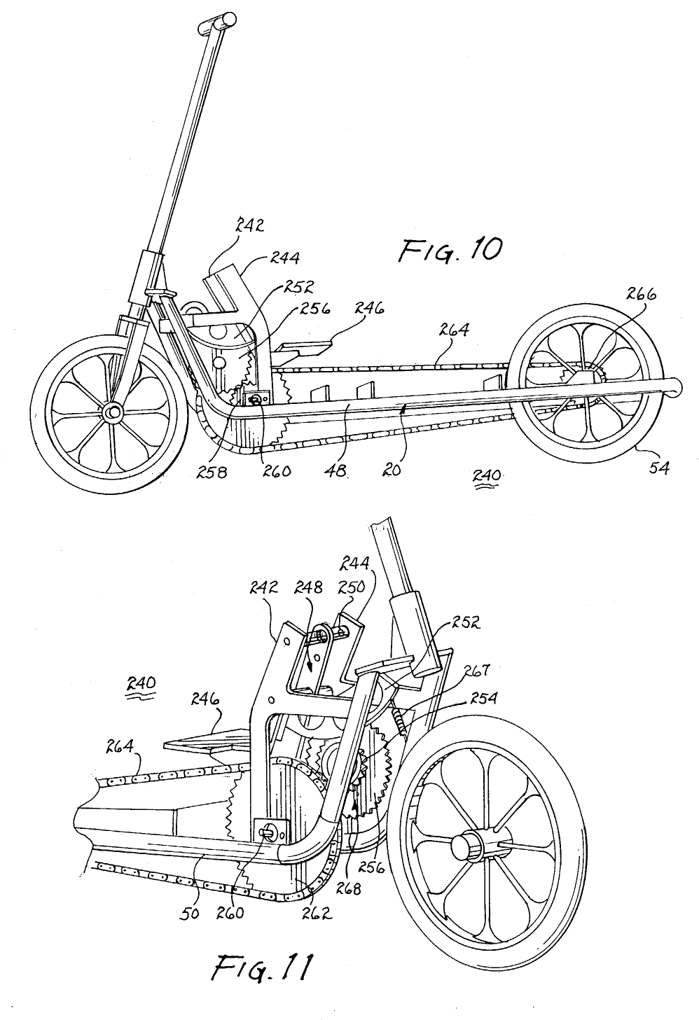

Referring jointly to FIGS. 10 and 11, a front drive variant 240 is illustrated. Common elements previously described have been assigned corresponding reference numerals. A pair of frame members 242, 244 are secured to frame 20 of variant 240. A footpad 246 or peg is attached to a variant lever assembly 248, which variant lever assembly is pivotally mounted on a shaft 250 supported by members 242, 244. A curved bar 252, similar to bar 86 shown in FIGS. 4 and 5, meshes with the teeth of a sprocket 254. The sprocket is mounted through a one way clutch upon a shaft extending between members 242, 244 (the shaft is not shown for purposes of clarity of illustration). A gear 256 is in engagement with sprocket 254 whereby the gear will rotate commensurate with rotation of sprocket 254. A further gear 258 is mounted upon a shaft 260 supported by frame 20 or the shaft may be supported by members 242, 244. A sprocket 262 is also mounted on shaft 260 and in mechanical engagement with gear 258 to provide rotation of sprocket 262 commensurate with rotation of the gear. A chain 264, such as a conventional bicycle chain, interconnects sprockets 262 with sprocket 266 associated with wheel 54 through a one way clutch. Thereby, rotation of sprocket 262 will impart commensurate rotation of sprocket 266 as a function of the ratio of teeth of the respective sprockets. It may be noted that gear 256 is of greater diameter than gear 258 whereby the rate of rotation of gear 258 is greater than that of gear 256 as a function of the ratio of their respective number of teeth. Thereby, gear mechanism 268 mounted at the front of variant 240 provides an opportunity to impart the relatively high speed of rotation to wheel 54 as a function of repetitive pumping of footpad 246. Pivotal return of variant lever assembly 248 may be effected by a spring 267 interconnecting bar 252 (or another appropriate element of variant lever assembly 248) with frame 20 or one of members 242, 244. Thereby, after the footpad 246 or a peg is depressed to urge ultimate rotation of wheel 54 and upon release of pressure on the footpad or peg it will automatically return to its raised position.

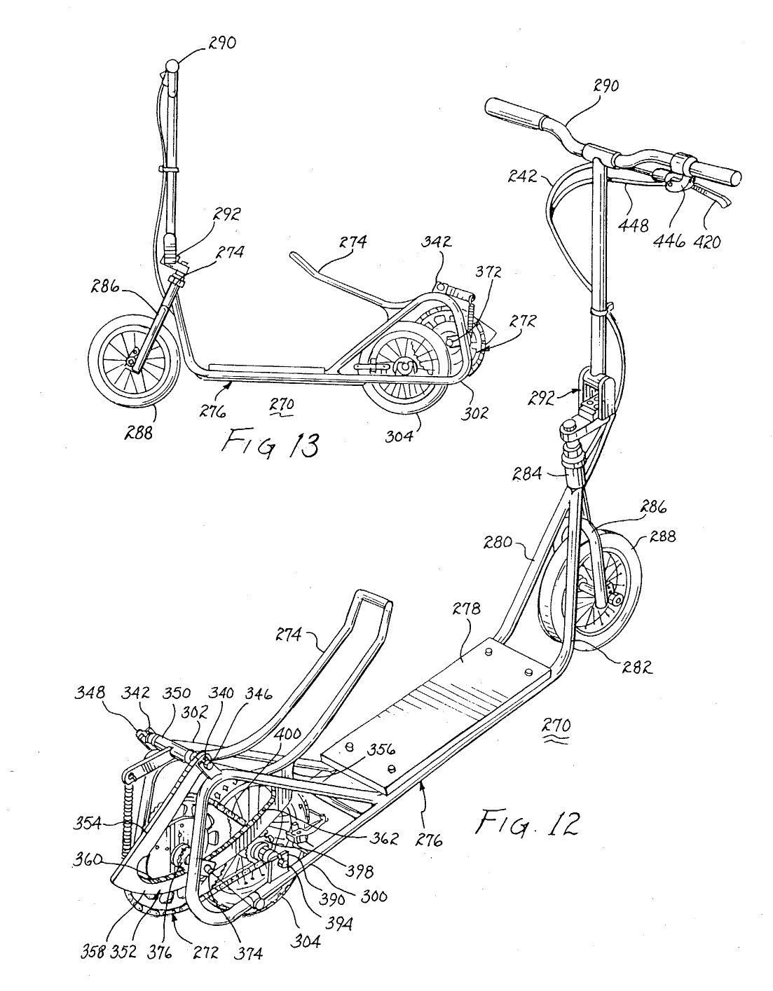

Referring to FIG. 12, there is illustrated a further scooter 270 having a gear mechanism 272 actuated by a foot operated lever 274. Components of scooter 270 will be broadly described with joint reference to FIGS. 12, 13 and 14. A frame 276 includes a central section supporting a platform 278 upon which a rider may stand. A pair of forwardly located uprights 280, 282 join with one another and support a journal 284 for a fork 286 supporting front wheel 288. The fork supports handlebars 290 through a pivot mechanism 292. As is well known, by turning the handlebars, the front wheel will turn to provide steering for the scooter. The rear of frame 276 includes a pair of tubing sections 300, 302 for supporting gear mechanism 272 and rear wheel 304.

Referring jointly to FIGS. 15 and 16, the structure attendant front wheel 288 will be described in further detail. The front wheel is journaled within fork 286 in the conventional manner except that the fork may include a pair of opposed brackets 310 (of which only one is shown) having a plurality of holes 312 to permit vertical repositioning of axle 314. Conventional scooters have a vertical stanchion supporting the handlebars. Such orientation is sometimes uncomfortable and may be awkward, depending upon the physical stature of the rider. To permit fore and aft positioning of handlebars 290, to pivot mechanism 292 is employed. A stanchion 316 extends upwardly from journal 274 and may form a part of fork 286. The stanchion supports a base 318 extending forwardly thereof. Elements 320, 322 of a fork 324 are interconnected by a cylindrical bar 356, which may be solid, as shown, or hollow. A plate 328 is secured to base 318 by a plurality of bolts 330 to capture bar 326 therebetween and within grooves 332, 334 configured to correspond with the external dimensions of the bar. By loosening bolts 330, handlebars 290 and conduit 291 interconnecting the handlebars with fork 324 may be pivoted fore and aft to a position comfortable for the rider. Thereafter bolts 330 are tightened to fixedly capture bar 326 between base 318 and plate 328.

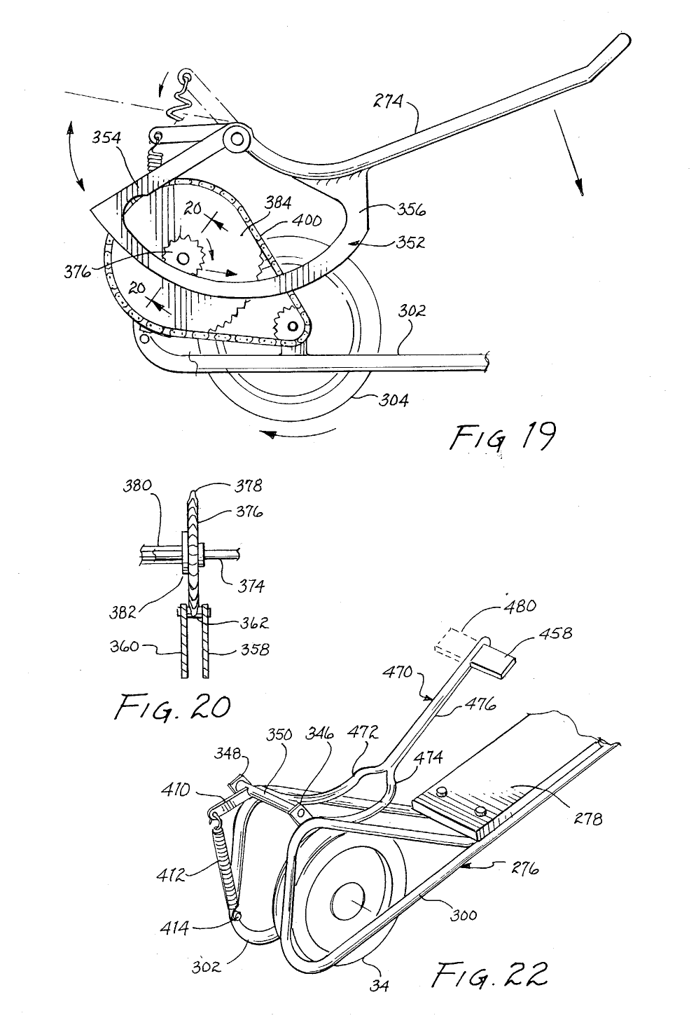

Referring jointly to FIGS. 12, 17, 18, 19 and 20, details attendant gear mechanism 272 will be described. Tubing sections 300, 302 include a pair of ears 340, 342 for receiving and supporting a shaft 344 secured to the ears by nuts 346, 348 in the conventional manner. A sleeve 350 is rotatably supported upon shaft 344. The two legs of lever 274 are attached to and extends forwardly from sleeve 350 whereby the lever is free to pivot about shaft 344. An arcuate bar 352 is secured to lever 274 through arm 354 and arm section 356 the locus of the arc of bar 352 is coincident with the longitudinal axis of shaft 344. Bar 352 may have attached thereto a length of conventional bicycle chain or it may include a pair of sidewalls 358, 360 between which are mounted a plurality of rods 362 spaced apart from one another commensurate with corresponding rods of a conventional bicycle chain; preferably, these rods are short sleeves supported by a bearing(s) to render them freely rotatable upon engagement with the teeth of a sprocket. Tubing sections 300, 302 include a pair of ears 370, 372 for supporting a further shaft 374 secured to the ears by nuts or the like. A first sprocket 376 is rotatably mountable upon shaft 374. As particularly shown in FIG. 20, teeth 378 of first sprocket 376 engage rods 362. As bar 352 is caused to curve illinearly translate as of result pivotal movement of lever 374, rotational motion to first sprocket 376 is imparted by rods 362 sequentially engaging teeth 378. To permit rotation of first sprocket 376 relative to shaft 374, it is supported upon a sleeve 380 in rotatable engagement with shaft 374. A clutch 382 may be incorporated intermediate first sprocket 376 and sleeve 380 to permit rotation of the first sprocket in one direction without commensurate rotation of the sleeve. A second sprocket 384 is secured to sleeve 380 whereby rotation of first sprocket 376, at least in one direction, will result in corresponding rotation of the second sprocket.

A further pair of ears 390, 392 attached to tubing sections 300, 302 support an axle 394, which axle is secured to the ears by nuts or the like. A sleeve 396 is supported by axle 394. A third sprocket 398 is secured to sleeve 396 directly or through a one way clutch. Wheel 304 is secured to sleeve 396 directly or through a hub in a conventional manner. A chain, such as a conventional bicycle chain 400, interconnects second sprocket 384 with third sprocket 398. The ratio of number of revolutions of third sprocket 398 relative to second sprocket 384 is a function of the ratio of the teeth of the respective sprockets.

Upon curvilinear motion of bar 352, first sprocket 376 will be caused to rotate a number of revolutions as a function of the number of rods 362 present per stroke of lever 374. Rotation of first sprocket 376 will result in commensurate rotation of second sprocket 384. The rotation of the second sprocket will be translated to third sprocket 398 via chain 400. The number of revolutions of the third sprocket for each revolution of the second sprocket is a function of the respective ratio of teeth of the second and third sprockets. Rotation of the third sprocket will result in commensurate rotation of wheel 384. It is therefore evident that downward movement of lever 274 will result in rotation of wheel 304 as a function of the extent of curvilinear travel of bar 352 and the gear ratio between the second and third sprockets.

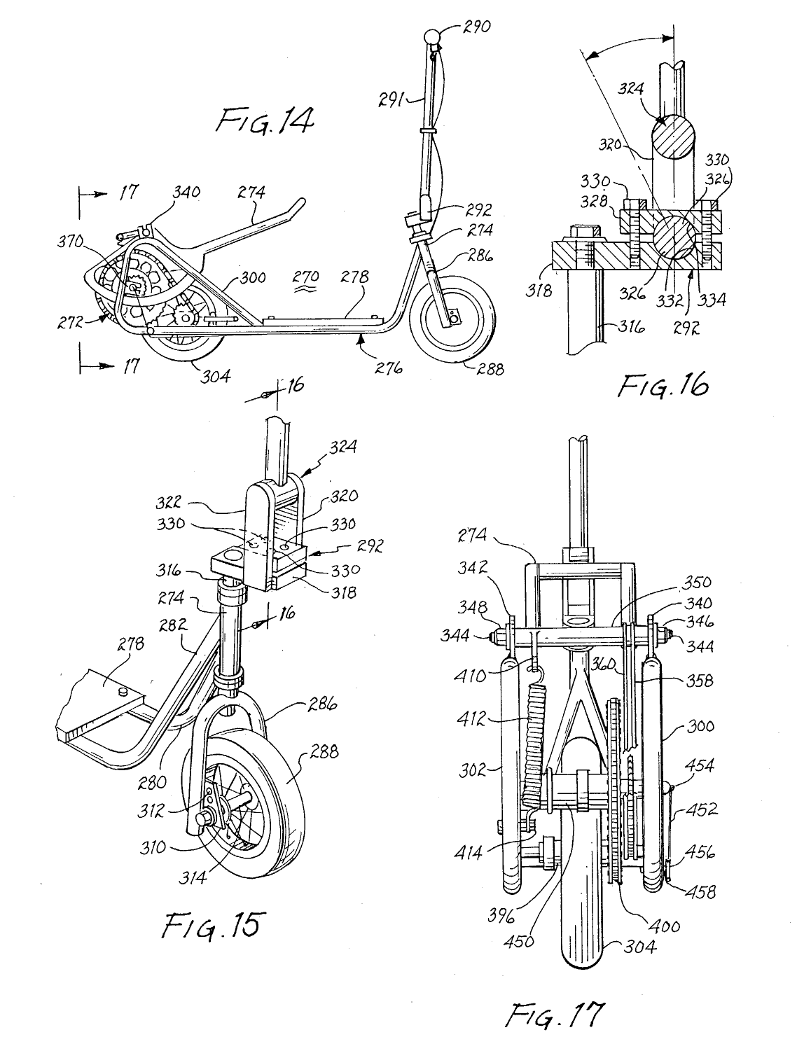

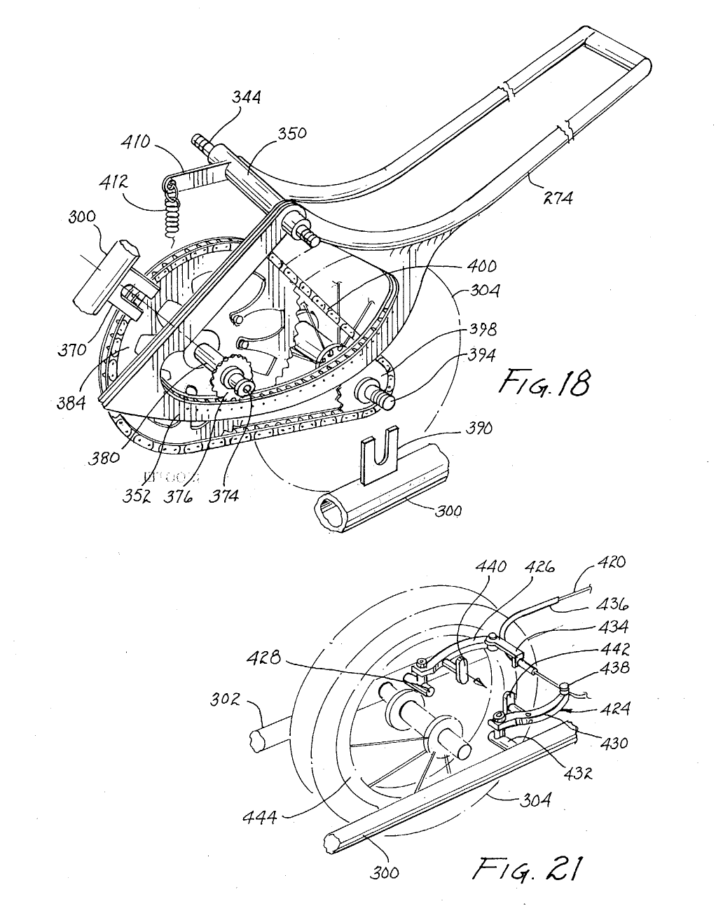

Referring primarily to FIGS. 17, 18 and 19, the return movement of lever 274 will be described. An arm 410 extends from sleeve 350, which arm will rotate commensurate with the sleeve and as a function of pivotal movement of the lever. A spring 412 interconnects lever 410 with a pin 414 or other anchor point secured to tubing section 302. Accordingly, downward movement of lever 274 will result in upward movement of arm 410 causing spring 412 to extend. Upon reduction of a downward force upon lever 274, spring 412 will compress and result in downward movement of the lever to bring it back to its initial position.

Referring primarily to FIGS. 12 and 22, the brake mechanism for the scooter will be described. A hand operated lever 420 is mounted upon handlebar 290. A sheathed cable 422 is routed downwardly along frame 276 for engagement with a pair of brake calipers 424 mounted proximate rear wheel 304. Caliper 426 is pivotally mounted upon a stanchion 428 extending from tubing section 302. Caliper 430 is similarly pivotally mounted upon stanchion 432 extending from tubing section 300. Caliper 426 includes a pivotally attached gripping element 434 for retainingly engaging sheath 436 of the brake cable assembly. Cable 420 is captured by a retaining element 438 or caliper 430. Brake pads 440, 442 extend from calipers 424, 430, respectively, for frictionally engaging corresponding sides of rim 444 of wheel 304. By squeezing lever 420, calipers 426, 430 are caused to rotate toward one another, which rotation brings the brake pads to bear against the rim. The resulting friction between the brake pads and the rim results in a braking action of wheel 304.

To provide further options to a rider, scooter 270 may include a gear shift mechanism. For example, sleeve 380 would be replaced by a conventional bicycle hub having an internal gear shift mechanism 450 (shown in FIG. 17). Actuation of the gear shift mechanism may be by manipulation of a lever 446 mounted on handlebar 290, as is conventional for bicycles. The gear shift mechanism is actuated by a sheathed cable 448 extending from lever 446 on the handlebar, along the frame and to the gear shift mechanism and terminated by cable 452 engaging a chain 454 extending into the gear shift mechanism in the conventional manner used for bicycles. One or more pulleys 456 rotatably secured to tubing section 300 by a bracket 458 and/or other parts of frame to guide cable 452 may be employed. Alternatively, such a gear shift mechanism may be incorporated in a hub as part of or replacement for sleeve 396.

Referring to FIG. 22, there is shown an alternate configuration of lever 274. Lever 470 includes a pair of rods elements 472, 474 extending from sleeve 350 and supporting an extension 476. It is preferable that two elements of the lever be secured to the sleeve, as depicted for both levers 274 and 470, to prevent twisting and torsional loads that may be placed upon the lever during a pumping action. The terminal end of extension 476 may include a single pad 478 extending to one side or a pair of pads (478, 480), as illustrated in phantom lines.

In operation, scooter 270 may be used in the conventional manner described above. For greater speed, or just a change of pace, a rider would use one of his feet to pump lever 274. Such pumping action would result in commensurate rotation of wheel 304. The rate of rotation of the wheel, and hence the speed of the scooter, would be a function of the repetition rate with which lever 274 is pumped. If gear shift mechanism 450 is used, greater speed may be achieved by downshifting, or the ease of riding up a hill would be enhanced.

We claim:

1. A foot pump scooter including a handlebar, said foot pump scooter comprising in combination:
a) a frame for supporting a steerable front wheel and a rear wheel having an axis of rotation;
b) a gear mechanism adapted to impart rotary motion to said rear wheel; and
c) said gear mechanism including a pivotally mounted spring loaded lever adapted to be pumped by a rider to produce a curvilinear motion of a bar to rotate a sprocket having a further axis of rotation, said further axis of rotation being displaced from said axis of rotation of said rear wheel for actuating said gear mechanism.

2. A foot pump scooter as set forth in claim 1 wherein said gear mechanism includes a one way clutch for imparting rotary motion to said rear wheel only in one direction of rotation.

3. A foot pump scooter as set forth in claim 1 wherein said gear mechanism includes a gear shift mechanism.

4. A foot pump scooter as set forth in claim 1 wherein said gear mechanism includes said sprocket, a second sprocket mounted on an axis common with said further axis, a third sprocket mounted on an axis common with said axis of rotation of said rear wheel and a chain interconnecting said second and third sprockets for urging rotation of said third sprocket at a greater rate of rotation than said sprocket.

5. A foot pump scooter as set forth in claim 1 wherein said gear mechanism includes a gear shift mechanism adapted for altering the ratio of rotation between said sprocket and said rear wheel and a manually operated lever for changing the gears of said gear shift mechanism.

6. A foot pump scooter as set forth in claim 5 wherein said gear shift mechanism is located in an axis common with said further axis.

7. A foot pump scooter as set forth in claim 4 wherein said gear mechanism includes a gear shift mechanism adapted for altering the ratio of rotation between said sprocket and said rear wheel and a manually operated lever for changing gears of said gear shift mechanism.

8. A foot pump scooter as set forth in claim 7 wherein said gear shift mechanism is located in an axis common with said further axis.

9. A foot pump scooter as set forth in claim 1 including a pivot mechanism for repositioning and handlebar fore and aft.

10. A foot pump scooter as set forth in claim 1 including a brake assembly for braking rotation of said rear wheel.

11. A method for urging movement across a surface of a scooter having a handlebar attached to a steerable front wheel and a rear wheel, said method comprising the steps of:
a) depressing a spring loaded lever from an upper position to a lower position to produce curvilinear motion of an arcuate bar;
b) rotating an initial sprocket responsive to movement of the bar resulting from exercise of said step of depressing;
c) urging rotation of the rear wheel in one direction by rotating a final sprocket on an axis common with the rear wheel in response to said step of rotating; and
d) operating a gear shift mechanism interposed at a location intermediate the arcuate bar and the rear wheel to alter the ratio of rotation between the initial and the final sprockets.

12. The method as set forth in claim 11 wherein said step of operating includes the step of repositioning a manually operated lever to actuate the gear shift mechanism.

13. The method as set forth in claim 11 including the step of repositioning the handlebar fore and aft.

14. The method as set forth in claim 11 including the steps of rotating an intermediate sprocket in response to rotation of the initial sprocket and the step of urging rotation of the final sprocket with a chain engaging the intermediate and final sprockets.

15. A foot pump scooter comprising in combination:
a) a frame for supporting a steerable front wheel, a handlebar attached to said front wheel, a rear wheel and a platform therebetween;
b) a gear mechanism adapted to impart rotary motion to said rear wheel for urging forward motion of said scooter;
c) a spring returned lever adapted to be depressed by a rider's foot and having an arcuate bar for actuating a first sprocket of said gear mechanism; and
d) said gear mechanism including a second sprocket coupled with said first sprocket, a third sprocket fixedly coupled with said rear wheel, said third sprocket being coupled with said second sprocket by a chain.

16. A foot pump scooter as set forth in claim 15 wherein said gear mechanism includes a gear shift mechanism for coupling said first sprocket with said second sprocket and a manually operated lever for actuating said gear shift mechanism.

17. A foot pump scooter as set forth in claim 16 wherein said handlebar supports said manually operated lever.

18. A foot pump scooter as set forth in claim 17 including a brake assembly for braking said rear wheel and a further manually operated lever attached to said handlebar for actuating said brake assembly.

19. A foot pump scooter as set forth in claim 15 including a pivot mechanism adapted to permit fore and aft repositioning of said handlebar relative to said frame.

20. A foot pump scooter as set forth in claim 15 wherein said spring returned lever includes a pair of elements adapted to counter any torsional loads imposed.

21. A foot pump scooter comprising in combination:
a) a frame for supporting a steerable front wheel, a handlebar attached to said front wheel, a rear wheel and a platform therebetween;
b) a gear mechanism adapted to impart rotary motion to said rear wheel for urging forward motion of said scooter, said gear mechanism including a gear shift mechanism; and
c) a spring returned lever adapted to be depressed by a rider's foot and having an arcuate bar for rotating a sprocket of said gear mechanism.
